(19) United States
(12) Patent Application Publication
(10) Pub. No.: US 2018/0302116 A1
(43) Pub. Date: Oct. 18, 2018

(54) REMOVABLE CASING FOR AN ELECTRONIC DEVICE

(71) Applicant: SPYDER DIGITAL RESEARCH INC., Toronto (CA)

(72) Inventors: Michael NITTI, Toronto (CA); Brad CHEN, Mission Viejo, CA (US)

(73) Assignee: SPYDER DIGITAL RESEARCH INC., Toronto, ON (CA)

(21) Appl. No.: 15/574,094

(22) PCT Filed: May 13, 2016
(86) PCT No.: PCT/CA2016/000149

§ 371 Date: Nov. 14, 2017

Related U.S. Application Data
(60) Provisional application No. 62/162,583, filed on May 15, 2015.

(51) Int. Cl. H04B 1/3883; H02J 7/00; H04B 1/3888; H04M 1/02

(52) U.S. Cl. CPC H04B 1/3883; H02J 7/0047; H02J 7/0044; H02J 7/025; H04M 1/0262; H02J 2007/005; H04B 1/3888

(57) ABSTRACT

There is provided a removable casing for an electronic device, the casing including: a battery for powering the electronic device; a cavity for receiving the electronic device; a pivoting connector extending from the cavity, for interconnecting the electronic device to the battery; the pivoting connector configured to pivot between: a first position in which the connector extends at an angle relative to a rear surface of the casing, thereby allowing the electronic device to be connected to or disconnected from the connector when the electronic device is oriented at said angle to the back surface of the casing; a second position in which the connector is substantially parallel to the rear surface and allowing the electronic device, when connected to the connector, to be substantially parallel to the back surface and received within the cavity. The removable casing may have antimicrobial agents, wireless communication devices, or UV resistant coatings.

This application is a non-provisional of U.S. Application No. 62/162,583 filed 15 May 2015, entitled “REMOVABLE CASING FOR AN ELECTRONIC DEVICE”, incorporated herein by reference, and claims all benefit, including priority.

### FIELD

The present disclosure relates generally to apparatuses for providing external sources of power to mobile devices, and more particularly, to apparatuses that provide additional power while providing protection as a protective case for the mobile device.

### INTRODUCTION

Apparatuses for providing external power sources to mobile devices are known.

However, there are various deficiencies with the presently available external power sources.

### SUMMARY

In an aspect, there is provided a removable casing for an electronic device, the casing including: a battery for powering the electronic device; a cavity for receiving the electronic device; a pivoting connector extending from the cavity, for interconnecting the electronic device to the battery; the pivoting connector configured to pivot between: a first position in which the connector extends at an angle relative to a rear surface of the casing, thereby allowing the electronic device to be connected to or disconnected from the connector when the electronic device is oriented at said angle to the back surface of the casing; a second position in which the connector is substantially parallel to the rear surface and allowing the electronic device, when connected to the connector, to be substantially parallel to the back surface and received within the cavity.

In another aspect, the casing further includes an outer surface having a power indicator arranged to form at least part of a logo.

In another aspect, the power indicator is comprises a plurality of light sources.

In another aspect, the light sources comprise light emitting diodes.

In another aspect, the power indicator is configured to illuminate a subset of the light sources, the number of light sources in the subset corresponding to the power level of the battery.

In another aspect, at least one of the light sources is recessed from the outer surface.

In another aspect, the at least one light source is covered by a translucent casing.

In another aspect, the translucent casing is substantially flush with the outer surface.

In another aspect, the pivoting connector is configured to transmit power and data simultaneously.

In another aspect, the pivoting connector comprises at least one power pin and at least one data pin.

In another aspect, the at least one power pin and the at least one data pin are interconnected with at least one corresponding power pin and at least one corresponding data pin located at an outer surface of the removable casing.

In another aspect, the at least one corresponding power pin and the at least one corresponding data pin are spaced by a distance sufficient to minimize interference therebetween.

In another aspect, the casing further includes a bottom end configured to be received in a dock and the at least one corresponding power pin and the at least one corresponding data pin connect with pins on the dock when the bottom end is received in the dock.

In another aspect, the electronic device is a mobile phone.

In another aspect, the casing further including a wireless communication device configured to track data associated with the electronic device or the casing.

In another aspect, the wireless communication device is coupled to the casing and is configured to transmit signals tracking at least one of location, power status, data transmission status, and battery level.

In another aspect, the wireless communication device is configured to transmit a signal associated with an orientation or a position of the pivoting connector.

In another aspect, the casing further including an anti-microbial agent disposed substantially on or around the casing.

In another aspect, the anti-microbial agent is disposed during an initial plastic extrusion stage of production.

In another aspect, the anti-microbial agent is applied to an inner sleeve of the casing during an initial plastic extrusion stage of production.

In another aspect, the casing further including a UV-resistant coating disposed substantially on or around the casing.

In another aspect, the UV-resistant coating is applied using electronic static processes such that the UV-resistant coating becomes integral to the casing.

In another aspect, there is provided a kit including the casing of any one of the above and the dock.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is a front view of an electronic device retained within the removable casing, according to some embodiments.

FIG. 1B is a perspective view of the electronic device retained within the removable casing, from a rear-facing perspective, according to some embodiments.

FIG. 2A is a front view of a removable casing without an electronic device, according to some embodiments.

FIG. 2B is a top side view of the removable casing of FIG. 2A, according to some embodiments.

FIG. 2C is a left side view of the removable casing of FIG. 2A, according to some embodiments.

FIG. 2D is a right side view of the removable casing of FIG. 2A, according to some embodiments.

FIG. 3 is a rear side view of the removable casing with a power display provided within a design on the rear of the removable casing, according to some embodiments.

FIG. 4 is a magnified view of the design of FIG. 3, according to some embodiments.

FIG. 5 is a cross-sectional view of the removable casing of FIG. 3, according to some embodiments.

FIG. 6A is a partial perspective view of the removable casing taken from a rear perspective, illustrating sample adaptors that are disposed on the bottom edge of the removable casing, according to some embodiments.

FIG. 6B is a magnified partial sectional view magnifying the section bounded by the dashed line of FIG. 6A, according to some embodiments.

FIG. 7A is a magnified sectional view of the pivot used to pivot the pivotable connector, the pivot and the pivotable connector in a pivoted position, according to some embodiments.

FIG. 7B is a magnified sectional view of the pivot used to pivot the pivotable connector, the pivot and the pivotable connector in an upright position, according to some embodiments.

FIG. 8A is a perspective view of a dock, according to some embodiments.

FIG. 8B is a top view of the dock of FIG. 8A, according to some embodiments.

FIG. 9 is a side view of the dock retaining a removable casing, according to some embodiments.

FIG. 10 is a top view of two sides of the removable casing indicative of a location upon where a wireless communication device (e.g., a RFID chip) is provided, according to some embodiments.

FIG. 11 is a perspective view of the removable casing and/or dock further comprising one or more wireless charging receiving chips or coils to support wireless charging in one or more wireless charging formats, in accordance with some embodiments.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

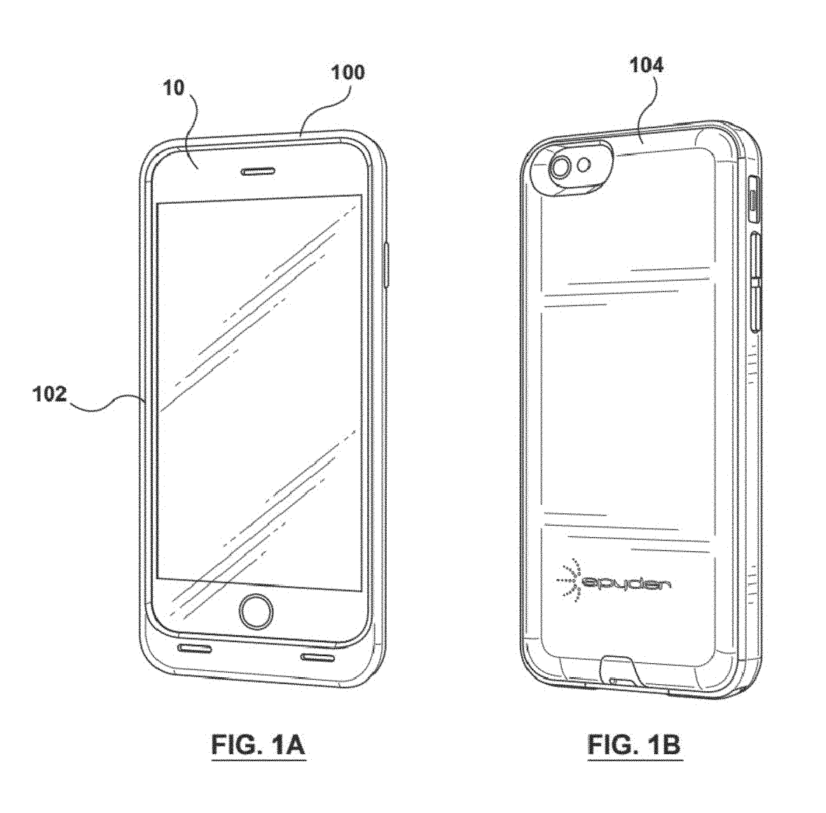

FIG. 1A is a front view of an electronic device 10 retained within a cavity of the removable casing 100, according to some embodiments.

The electronic device 10 may include various types of electronic devices, including smart phones, mobile phones, tablet computers, smart watches, etc. The electronic device 10 includes a battery internal to the electronic device 10.

The present disclosure, in some embodiments, provides a removable casing 100 for an electronic device 10, the removable casing 100 being configured to house a power supply for providing supplemental power external to the internal power supply of the electronic device 10. For example, the power supply may be provided in the form of a battery, which, in some embodiments, may be selectively enabled to deliver power to the electronic device 10.

The battery may include various battery technologies, configurations, and/or materials, such as a lithium ion battery, electrochemical cells, voltaic cells, etc. In some embodiments, the battery is configured to be rechargeable. In some embodiments, the battery has an additional water-proofing seal.

In some embodiments, removable casing 100 has a flexible front lip 102 that retains the electronic device 10. The flexible front lip 102 is configured to flex such that the cavity is shaped such that electronic device 10 can be received. The flexible front lip 102 may then return to a position whereby the flexible lip 102 securely retains the electronic device 10 within the cavity.

FIG. 1B is a perspective view of the electronic device 10 retained within the removable casing 100, from a rear-facing perspective, according to some embodiments. As illustrated in FIG. 1B, the removable casing may have a back surface 104.

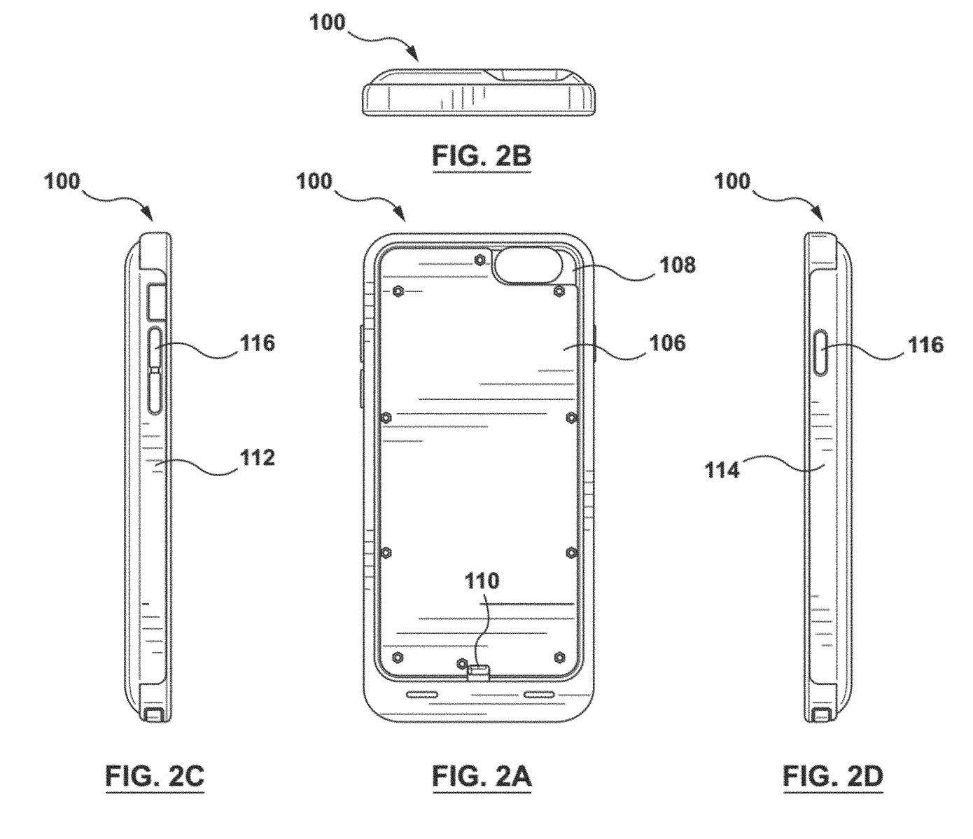

FIG. 2A is a front view of a removable casing 100 without an electronic device 10, according to some embodiments.

The removable casing 100 may be manufactured with separate components which are adhered and/or otherwise coupled to one another to form a single, integral removable casing 100. The components may include a battery, an inner sleeve 106 for providing shock absorption and water resistance, an outer shell 108 for providing protection for an electronic device 10 against damage, and adapter interfaces for providing power and data communications to/from the electronic device 10.

The inner sleeve 106 is formed of one or more elastic materials, such as thermoplastic elastomer, and may be configured for retaining and/or receiving an electronic device 10. In some embodiments, the inner sleeve 106, during/after receiving the electronic device 10, forms a protective water-resistant seal in relation to the electronic device 10. For example, the inner sleeve 106, through for example, the flexible front lip 102, may conform to the dimensions of the front face of the electronic device 10, and maintain a barrier that may repel and/or otherwise reduce the penetration of liquids (e.g., water) into the cavity formed by the inner and outer case 108.

The outer shell 108 may be formed of a resilient material, such as polycarbonate, and is configured to provide protection for the electronic device 10 against damage (e.g., scratches and damage from drops).

In some embodiments, the outer shell 108 may be infused with an antimicrobial agent (e.g., SilverShield™). This may be performed at the initial plastic extrusion stage of production when pellets are first melted. Performing this step may help ensure that the removable casing 100 will maintain antimicrobial properties even if it is scratched. In some embodiments, the antimicrobial agent is a powder. In some embodiments, the antimicrobial agent may be alternatively or also applied to the inner sleeve 106 at the initial extrusion stage.

In some embodiments, the outer shell 108 may, in addition, or alternatively, include a ultraviolet (UV) resistant outer coating designed to be resistant to usage in a UV sanitation device. While some embodiments include anti-microbial coatings and/or agents, some environments (e.g., hospitals) are using UV lights for anti-microbial protocols.

Accordingly, a UV resistant outer coating may be helpful for situations where electronic devices 10 are required to be placed into UV chambers for sanitation purposes. For example, paints on cases are normally not UV resistant, and in some embodiments, electrostatic processes similar to anodizing are applied. For example, through the electrostatic processes, the paint may become integral to the plastic.

In manufacture, the inner sleeve 106 and outer shell 108 may be adapted such that the inner sleeve 106 and outer shell 108 are combined to form a single integral removable casing 100. For example, a removable casing 100 for sale to a customer may include the inner sleeve 106 and the outer shell 108 adhered together during manufacture. The inner sleeve 106 and outer shell 108 may be finished in a rubber paint to increase friction and decrease the chance of dropping by a user (e.g., due to slippery hands).

The final rubber paint coating may be infused with the antimicrobial agent when the paint coating is mixed, prior to application onto polycarbonate.

The removable casing 100 may be provided to a user as a unibody removable casing 100, so that the user does not have to assemble the case around the electronic device 10. In this embodiment, the removable casing 100 consists of a single unitary unit.

The adapter interfaces for providing power and data communications to/from the electronic device 10 may include various adapters designed for interoperability with various standards. In some embodiments, the removable casing 100 includes a pivotable connector 110 (e.g., a male connector designed for the Lightning™ standard) that may be provided at a side of the case (e.g., at the inside bottom of the case). The pivotable connector 110 may be used to communicate with and transfer power to the electronic device 10.

Where the pivotable connector 110 is designed for the Lightning™ standard, the pivotable connector 110 may include eight pins, the pins designed to provide capabilities, such as data transmission, power transmission, identification/control signals, ground, etc., and may be provided in the form of differential pairs of pins.

In some embodiments, the pivotable connector 110 is designed for interoperability with the Universal Serial Bus™ (USB) family of standards, including, for example, Micro USB™, Mini USB™, USB™, USB-A™, etc.

The case may include internal circuitry that may be used for various functions, such as controlling data and/or power transmission. The internal circuitry may be a circuit board that acts as a conduit between the pivotable connector 110 which is configured for mating with a complementary adapter of the electronic device 10, and a second adapter that is disposed such that the case may mate with a power and/or data source that is external to the case. For example, the power and/or data source may be a workstation, another electronic device, an outlet, etc.

In some embodiments, the second adapter is a female Micro USB connector.

The internal circuitry transfers both power to/from the battery inside the case, and also to the re-chargeable battery inside the electronic device 10 (e.g., when the case is plugged in to an external power source, the removable casing 100's battery and/or the electronic device 10's internal battery may be charged). In some embodiments, both the electronic device 10's internal battery and the case battery may be charged simultaneously.

The internal circuitry may also be configured to transfer data to and from the electronic device 10 to an external device that is connected through the second adapter. For example, the internal circuitry may be configured to transfer data (e.g., photos, music, videos, documents) to a workstation, another electronic device 10, etc. The circuit board may be configured to manage the rate of speed with which power and/or data is transferred.

The internal circuitry may contains safety technology to reduce (e.g., minimize) the chance of fire from the battery, for example, by detecting over-cycling, short-circuit and/or over-heating of the battery.

The removable casing 100 may be configured to optionally interoperate with a dock 200. The removable casing 100 may include several pins that are used for facilitating power and/or data transfer between the electronic device 10, the battery, an external power source and/or an external device. For example, power may be provided to the battery and/or the internal battery of the electronic device 10, and data may be transferred between the electronic device 10 and external devices by way of the dock 200.

FIG. 2B is a top side view of the removable casing 100 of FIG. 2A, according to some embodiments.

FIG. 2C is a left side view of the removable casing 100 of FIG. 2A, according to some embodiments.

The left side 112 of a sample removable casing 100 is depicted, having depressible button covers 116 (configured to facilitate the depressing of buttons disposed on the left side of the electronic device 10 by a user through the removable casing 100).

FIG. 2D is a right side view of the removable casing 100 of FIG. 2A, according to some embodiments.

The right side 114 of a sample removable casing 100 is depicted, having depressible button covers 116 (configured to facilitate the depressing of buttons disposed on the right side of the electronic device 10 by a user through the removable casing 100).

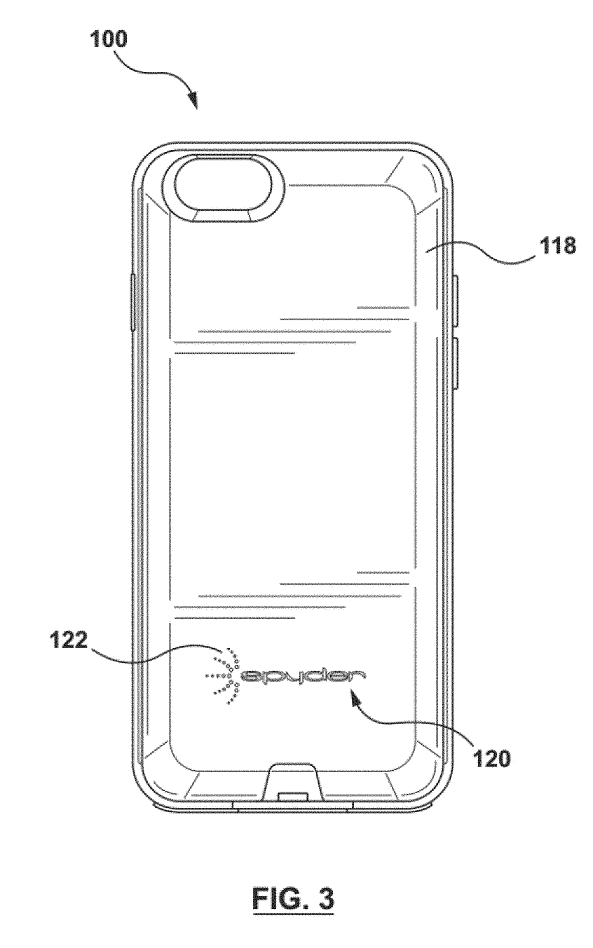

FIG. 3 is a rear side view of the removable casing 100 with a power display provided within a design on the rear of the removable casing 100, according to some embodiments.

The internal circuitry may also communicate with one or more light sources 126 which may be disposed on the back side 118 of the removable casing 100.

The light sources may include various types of light sources, such as incandescent light bulbs, light emitting diodes (LEDs), organic LEDs, halogen lights, xenon lights, high intensity discharge lights, etc.

In some embodiments, the light sources 126 may comprise one or more LED lights, and may be provided such that a logo indicator 122 (e.g., a claw, a spider shape) may be configured to light up based on control inputs from the internal circuitry, for example, indicating how much of the battery is charged, and/or indicating that the battery is in the process of charging. A subset of the light sources 126 may be illuminated to illustrate the power level of the battery, the number of light sources in the subset corresponding to the power level of the battery.

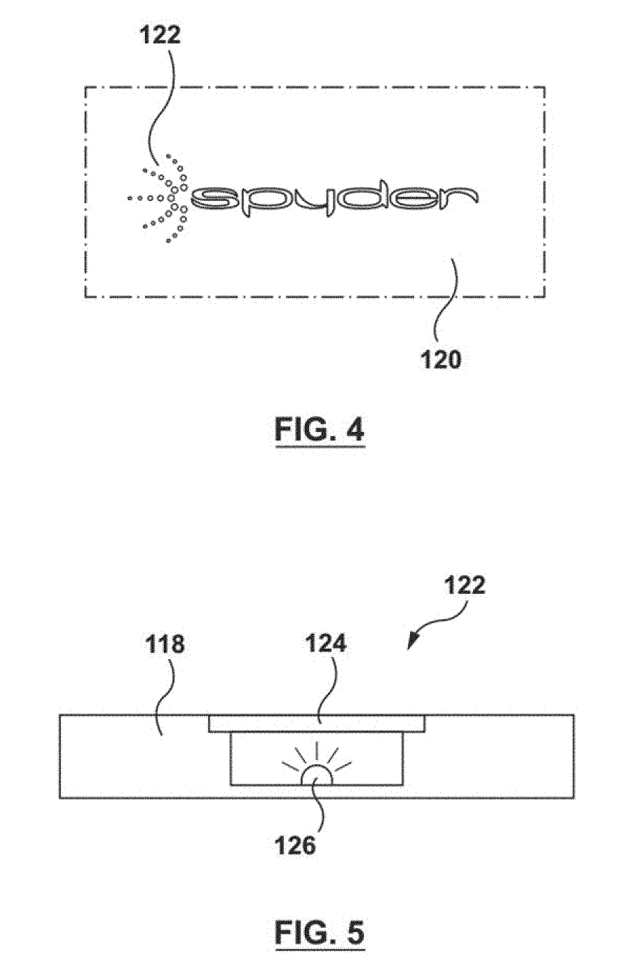

FIG. 4 is a magnified view of the design of FIG. 3, according to some embodiments.

As indicated, the logo indicator 122 may light up to provide indications in relation to the power status of the battery.

FIG. 5 is a cross-sectional view of the removable casing 100 of FIG. 3, according to some embodiments. In FIG. 5, logo indicator 122 is depicted in the magnified cross-section, having a translucent cover 124, one or more light sources (e.g., LED 126), embedded into back side 118.

As illustrated, in some embodiments, the LEDs 126 may be recessed from the outer surface. The LEDs 126 may also be covered by the translucent cover 124, the translucent cover 124 being substantially flush with the outer surface.

The combination of the translucent cover 124 and recessed lights 126 may have potential benefits as the inclusion of the power indicators is not intrusive in the overall look and feel of the removable casing 100. As the removable casing 100 may often be in various pockets of articles of clothing or carrying containers, the recessing of the lights 126 may prevent the lights 126 from being caught on other objects. Further, as the translucent cover 124 may integrated smoothly into the back of the removable casing 100, individuals viewing the removable casing 100 may not notice when the power indicators are not switched on. In this situation, the back side of removable casing 100 simply appears to include a glossy logo.

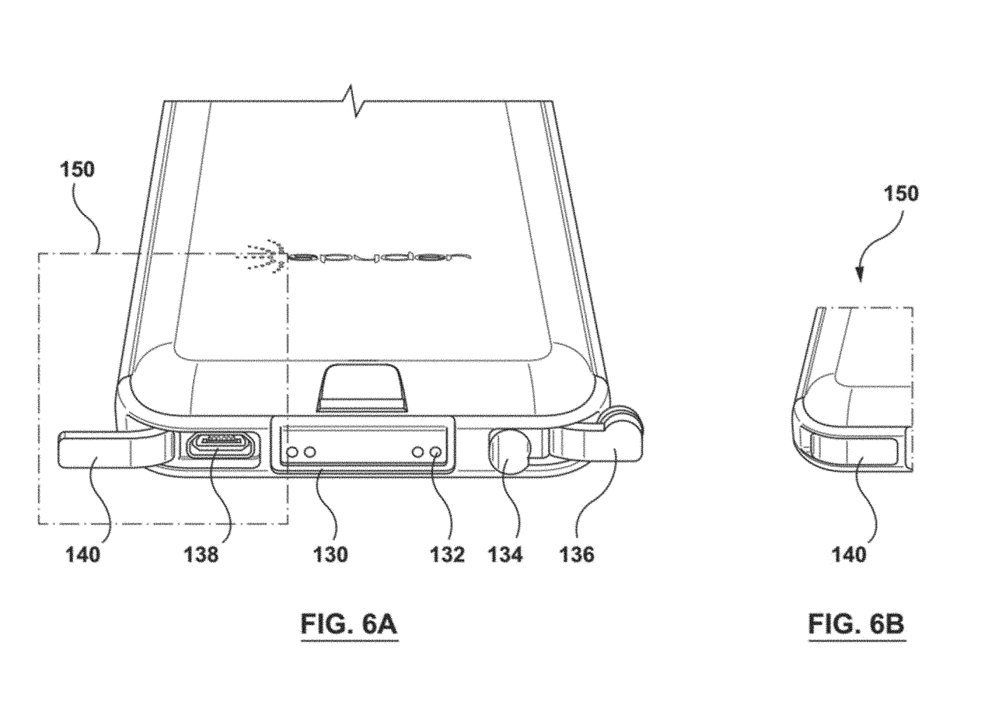

FIG. 6A is a partial perspective view of the removable casing 100 taken from a rear perspective, illustrating sample adaptors that are disposed on the bottom edge of the removable casing 100, according to some embodiments.

There may be various combinations of adaptors and connectors, and those illustrated in FIG. 6A are provided as examples. The adaptors and connectors may also be disposed on other edges and/or other sides of the removable casing 100.

In some embodiments, the removable casing 100 includes data pins 130, power pins 132, an audio connector channel 134 (which may be protected and/or otherwise selectively covered by audio flap cover 136), and an external data/power connector 138 (which may be protected and/or otherwise selectively coverable by connector flap cover 140).

The data pins 130 and power pins 132 may be configured to interoperate with a dock 200 and/or other external devices wherein the data pins 130 transfer data and the power pins 132 The data pins 130 and power pins 132 may be inset into the removable casing 100, and may be made of metallic materials. In an embodiment, there may are 4 pins; two data pins 130 and two power points 132. The power pins 132 and the data pins 130 may also be spaced apart such that there is a distance sufficient to minimize interference therebetween.

In some embodiments, the case is configured to interoperate and/or cooperate with one or more plugs (e.g., audio flap cover 136 or connector flap cover 140) adapted for various ports of the electronic device 10 (e.g., an audio headphone jack and/or a power/data port) to prevent dust and fluid (e.g., water) intrusion. The plug may include materials such as thermoplastic elastomers so that the plugs have elastic characteristics and may conform to the dimensions of the plugs to form a seal.

FIG. 6B is a magnified partial sectional view magnifying the section bounded by the dashed line of FIG. 6A, according to some embodiments.

In some embodiments, the pivotable connector 110 may be provided such that the pivotable connector 110 is capable of pivoting towards the front of the removable casing 100 (e.g., tilting forward by several degrees, such as 7 degrees). In other embodiments, the pivoting may be in a range of 5-20 degrees. In other embodiments, the range of degrees may be greater (e.g., up to 90 degrees or more). The pivoting feature may be provided to reduce the potential for damaging the adapter when a user is inserting an electronic device 10 into the case, or removing the electronic device 10 from the case.

The first position is configured such that the pivotable connector 110 extends at an angle relative to a rear surface of the removable casing 100, thereby allowing the electronic device 10 to be connected to or disconnected from the pivotable connector 110 when the electronic device is oriented at said angle to the back surface of the removable casing 100.

The pivotable connector 110 may be a male adapter adapted to be received by a complimentary female adapter of the electronic device 10.

The pivotable connector 110 may then be pivoted, relative to the case, into a second position in which the connector is substantially parallel to the rear surface and allowing the electronic device 10, when connected to the pivotable connector 110, to be substantially parallel to the back surface and received within the cavity.

For example, the electronic device 10 (and the pivotable connector 110) may be in an upright position relative to orientation of the removable casing 100. In some embodiments, the inner sleeve 106 is elastic and portions of the inner sleeve 106 (e.g., front lip 102) conform to the electronic device 10 such that the electronic device 10 is securely retained within the removable casing 100 and/or forms a protective seal around the electronic device 10.

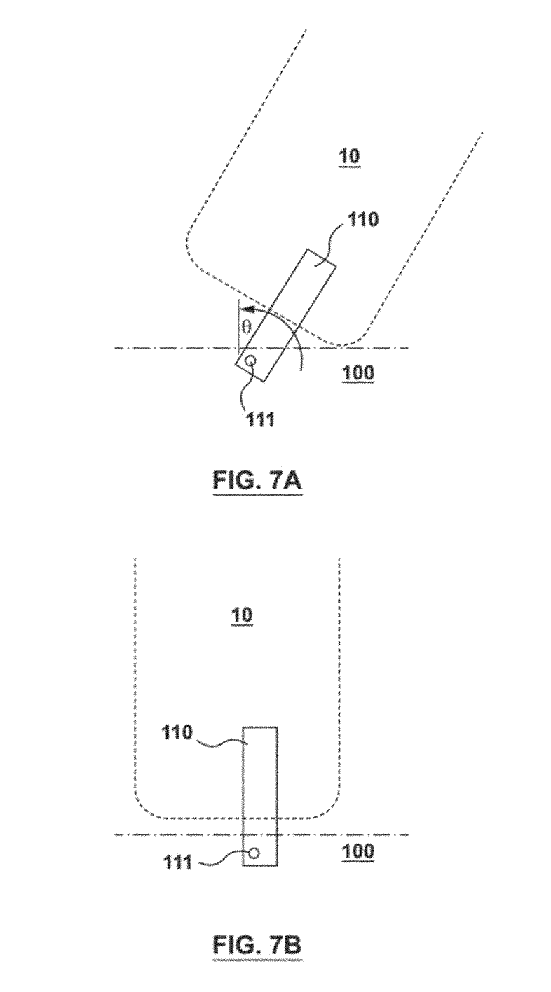

FIG. 7A is a magnified sectional view of the pivot 111 used to pivot the pivotable connector 110, the pivot 111 and the pivotable connector 110 in a pivoted position, according to some embodiments.

FIG. 7B is a magnified sectional view of the pivot 111 used to pivot the pivotable connector, the pivot 111 and the pivotable connector 110 in an upright position, according to some embodiments.

The pivot 111 and/or the pivotable connector 110 may be biased in the first position and/or the second position. For example, a biasing spring may be used to provide a resilient biasing feature. If the pivot 111 is biased in the first position, a user may more conveniently mate an electronic device 10 with the removable casing 100 as pivotable connector 110 is already provided in an angled, first position.

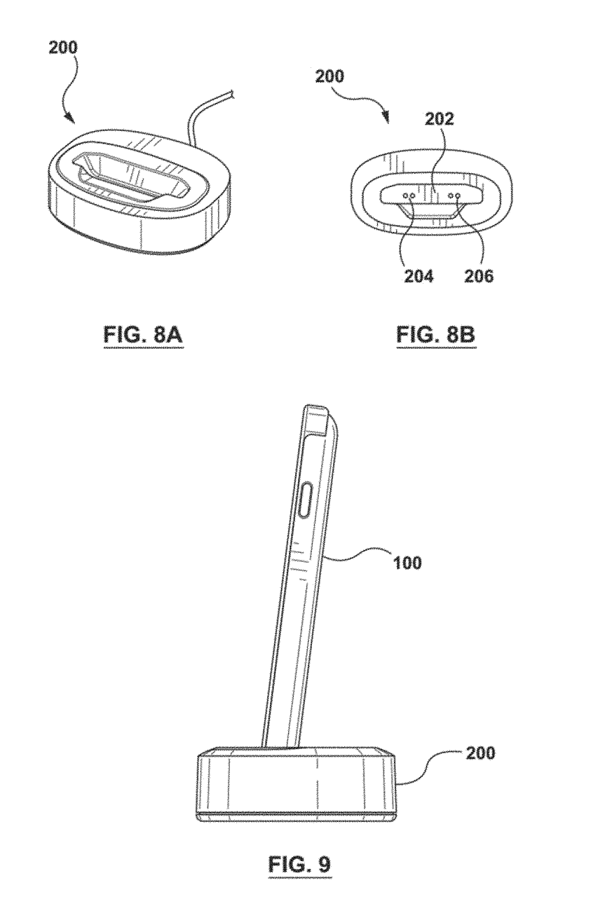

FIG. 8A is a perspective view of a dock 200, according to some embodiments.

FIG. 8B is a top view of the dock 200 of FIG. 8A, according to some embodiments. The dock may include a device receiving slot 202, power pins 204, and data pins 206. The device receiving slot 202 is configured to receive an electronic device 10.

In some embodiments, the device receiving slot 202 may be provided with and/or configured to receive a removable insert that is designed to permit a user to use different sized battery cases with the dock 200. For example, there may be different sized cases designed for devices such as the iPhone 6™, the iPhone 6 Plus™, the iPhone 5™ and other potential devices.

The power pins 204 may be configured to complementarily connect with power pins 132 of the removable casing 100, such that power may be transferred to the removable casing 100 and/or an internal battery of the electronic device 10 from an external power source coupled to the dock 200.

The data pins 206 may be configured to complementarily connect with data pins 130 of the removable casing 100, such that data may be transferred between the electronic device 10 and an external computing device coupled to the dock 200.

These connections may occur, for example, when the bottom of the removable casing 100 is inserted into the dock 200.

The power pins 204 and the data pins 206 may also be spaced apart such that there is a distance sufficient to minimize interference therebetween.

In some embodiments, the dock 200 may be sold as a kit along with the removable casing 100. In some embodiments, the dock 200 may be sold separately from the removable casing 100. The dock 200 is designed to provide a convenient method to recharge both the electronic device 10 and the battery of the removable casing during a time period. When plugged into a computer and/or external device's USB port, the dock 200 may also be configured to conduct various data transfer activities (e.g., synchronizing an electronic device 10 with a computer) simultaneously as the batteries are being recharged.

When the removable case 100 is placed into dock 200, and dock 200 is plugged into a personal computer, a mobile device screen may be configured to appear within the monitor of the personal computer and allow the user to interact with the mobile device via the keyboard attached to the personal computer.

In another embodiment, when the removable case 100 is placed into dock 200, and dock 200 is plugged into a personal computer, a user may be able to interact with the mobile device on the mobile device screen via the keyboard attached to the personal computer.

FIG. 9 is a side view of the dock 200 retaining a removable casing, according to some embodiments.

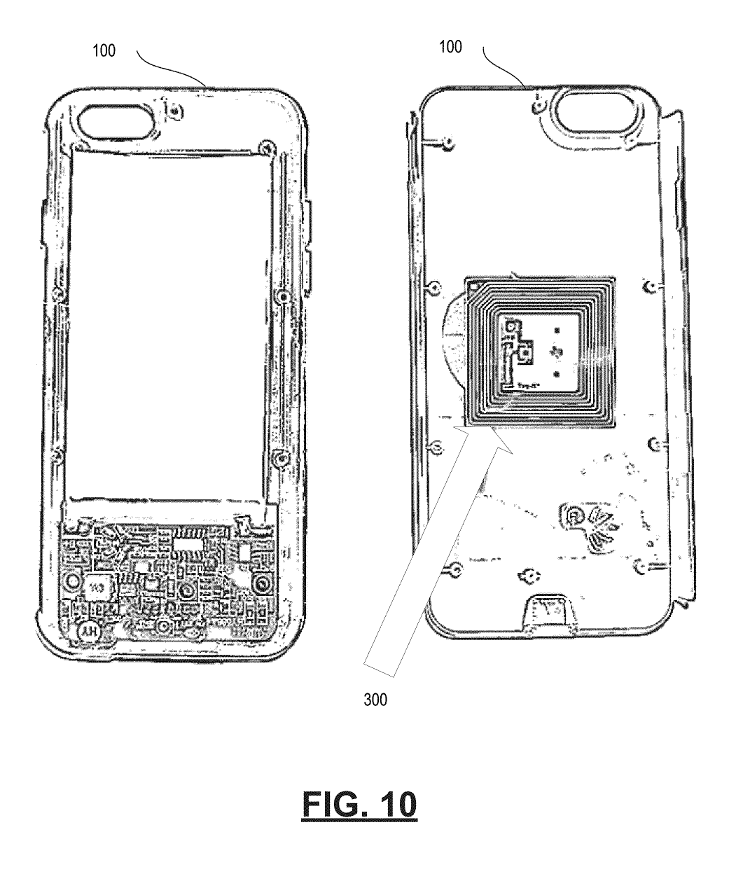

FIG. 10 is a top view of two sides of the removable casing indicative of a location upon where a wireless communication device (e.g., a RFID chip) is provided, according to some embodiments. The location illustrated is an example and other locations are possible. For example, the wireless communication device may be positioned on a top, a bottom, a corner, in the middle, etc.

As depicted, in an embodiment, the removable casing 100 may further comprise the wireless communication device 300 (e.g., a RFID chip) that may be positioned inside and/or proximate to the case, the wireless communication device 300, among other functionality, configured to track location, usage, and/or other various trackable data (e.g., movements, altitude, acceleration, rotation, battery levels, data transfer, power transfer, battery conditions).

For example, the wireless communication device 300 may be associated with functionality provided by the dock 200, such as providing a state determination signal indicative of when the removable casing 100 is being used with the dock 200, whether signals and/or power is being transferred by power pins 204 and data pins 206. The tracked signals being communicated by the wireless communication device 300 may be utilized to track characteristics of usage of the electronic device 10 retained within the removable casing 100, characteristics of usage of the removable casing 100 itself, characteristics of usage of the dock 200, status of a pivotable connector 110 (e.g., in a pivoted, non-pivoted position, or an angle thereof, where the angle may be a proxy for a determination that a removable casing 100 is properly attached), among others. The signals may be formatted in various ways, transmitted synchronously, asynchronously, in batch communications, in a push/pull configuration, etc.

The signals provided by the wireless communication device 300 may be useful, for example, in the context of a healthcare environment, such as a hospital. At a hospital, the signals may be used to indicate characteristics associated with the movement of people, objects, etc. For example, the signal may be used to track what rooms people have been in, based on tracking their phone. The signals may be utilized for tracking people based on movement of their phones, docks 200, and/or removable casings 100. In some embodiments, the data is provided to one or more healthcare systems, such as infectious disease monitoring systems, and they need to track movement of individuals, among others.

While some electronic devices 10 may enable some tracking of movement, the tracking may be substandard or not always present. Further, depending on various settings, a device manufacturer may not provide sufficient access to their location services to provide the location tracking data that these systems require. Integration of the wireless communication device 300 into a removable casing 100 and/or a dock 200 may provide a consistent and/or more reliable solution. For example, a hospital environment may mandate that a particular type of removable casing 100 be used regardless of the electronic device 10 type, all of the removable casings 100 having the wireless communication device 300 included. Accordingly, signals provided from the corresponding the wireless communication device 300s for each individual may be utilized to conduct various types of downstream analyses, such as infection spread tracking, etc.

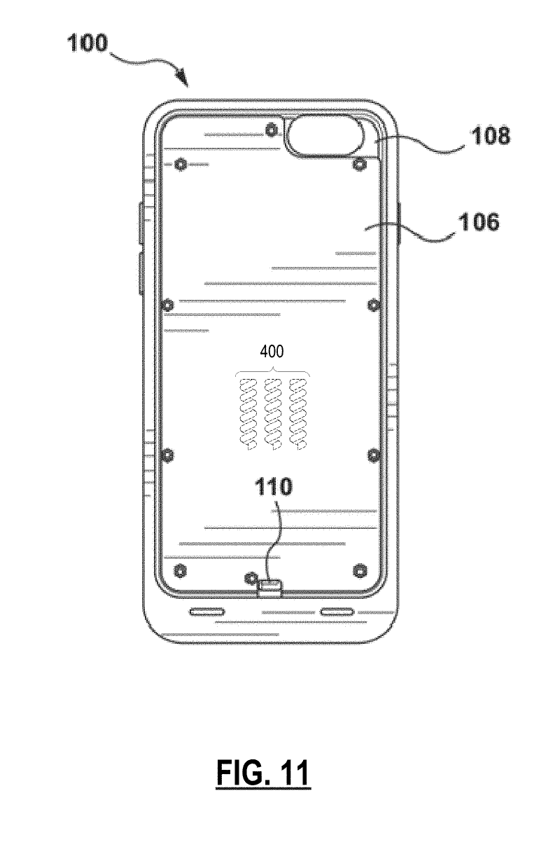

FIG. 11 is a perspective view of the removable casing 100 and/or dock 200 further comprising one or more wireless charging receiving chips or coils 400 to support wireless charging in one or more wireless charging formats, in accordance with some embodiments.

In a further embodiment, the one or more wireless charging receiving chips or coils 400 may be configured such that charging may be provided from multiple formats (e.g., Qi™, Powermat™, A4WP Rezence™).

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A removable casing for an electronic device, the casing comprising:
a battery for powering the electronic device;
a cavity for receiving the electronic device;
a pivoting connector extending from the cavity, for interconnecting the electronic device to the battery;
the pivoting connector configured to pivot between:
a first position in which the connector extends at an angle relative to a rear surface of the casing, thereby allowing the electronic device to be connected to or disconnected from the connector when the electronic device is oriented at said angle to the back surface of the casing;
a second position in which the connector is substantially parallel to the rear surface and allowing the electronic device, when connected to the connector, to be substantially parallel to the back surface and received within the cavity.

2. The casing of claim 1, further comprising an outer surface having a power indicator arranged to form at least part of a logo.

3. The casing of claim 2, wherein the power indicator is comprises a plurality of light sources, and wherein the power indicator is configured to illuminate a subset of the light sources, the number of light sources in the subset corresponding to the power level of the battery.

4. The casing of claim 3, wherein the light sources comprise light emitting diodes.

5. (canceled)

6. The casing of claim 3, wherein at least one of the light sources is recessed from the outer surface.

7. The casing of claim 6, wherein the at least one light source is covered by a translucent casing.

8. The casing of claim 7, wherein the translucent casing is substantially flush with the outer surface.

9. The casing of claim 1, wherein the pivoting connector is configured to transmit power and data simultaneously.

10. The casing of claim 9, wherein the pivoting connector comprises at least one power pin and at least one data pin.

11. The casing of claim 10, wherein the at least one power pin and the at least one data pin are interconnected with at least one corresponding power pin and at least one corresponding data pin located at an outer surface of the removable casing.

12. The casing of claim 11, wherein the at least one corresponding power pin and the at least one corresponding data pin are spaced by a distance sufficient to minimize interference therebetween.

13. The casing of claim 11, further comprising a bottom end configured to be received in a dock and the at least one corresponding power pin and the at least one corresponding data pin connect with pins on the dock when the bottom end is received in the dock.

14. The casing of claim 1, wherein the electronic device is a mobile phone.

15. The casing of claim 1, the casing further comprising a wireless communication device configured to track data associated with the electronic device or the casing.

16. The casing of claim 15, wherein the wireless communication device is coupled to the casing and is configured to transmit signals tracking at least one of location, power status, data transmission status, and battery level.

17. The casing of claim 15, wherein the wireless communication device is configured to transmit a signal associated with an orientation or a position of the pivoting connector.

18. The casing of claim 1, the casing further comprising an anti-microbial agent disposed substantially on or around the casing.

19. The casing of claim 18, wherein the anti-microbial agent is disposed during an initial plastic extrusion stage of production.

20. The casing of claim 18, wherein the anti-microbial agent is applied to an inner sleeve of the casing during an initial plastic extrusion stage of production.

21. The casing of claim 1, the casing further comprising a UV-resistant coating disposed substantially on or around the casing.

22. The casing of claim 21, wherein the UV-resistant coating is applied using electronic static processes such that the UV-resistant coating becomes integral to the casing.

23. A kit comprising the casing of claim 1 and the dock of claim 13.
